(19) United States
(12) Patent Application Publication
(10) Pub. No.: US 2005/0078756 A1
(43) Pub. Date: Apr. 14, 2005

(54) Encoding apparatus and encoding method

(75) Inventor: Hideyuki Narita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/913,385

(22) Filed: Aug. 9, 2004

(30) Foreign Application Priority Data
Aug. 21, 2003 (JP) 2003-297064

(51) Int. Cl. H04N 7/12

(52) U.S. Cl. 375/240.26

(57) ABSTRACT

According to the present invention, it becomes possible to avoid deterioration of image quality even when video image data is transmitted in real time. That is, when creating the first encoded data from the input image data, the skip encoded data which has the data amount less than this first encoded data is created. Then, based on the verification result of the verification means by using the virtual buffer means, the first encoded data is replaced with the skip encoded data, so that it is possible to adjust the data amount of the bit stream output outputted from the data output means.

### CROSS REFERENCE TO RELATED APPLICATION

This application claims priority from Japanese Priority Document No. 2003-297064, filed on Aug. 21, 2003 with the Japanese Patent Office, which document is hereby incorporated by reference.

### BACKGROLND OF THE INVENTION

1. Field of the Invention

The present invention relates to an encoding apparatus and encoding method for compressing and encoding an image data according to the MPEG (Moving Picture Experts Group) standard, for example.

2. Description of the Related Art

Conventionally, as a method for performing a compression process with respect to an image data, the MPEG standards have been proposed. There is an encoding apparatus for performing a process of compressing and encoding an image data according to the MPEG standards. In the above-mentioned encoding apparatus, the inputted image data is once stored in an image memory, then compressed and encoded. The compressed and encoded data is stored in a buffer memory, and then outputted as a bit stream.

In addition, the MPEG1 and MPEG2 standards are encoding methods for storing a color video image, which have been standardized by ISO (International Organization for Standardization) and IEC (International Electrotechnical Commission). As an encoding algorithm, the MPEG1 standard employs the motion compensation prediction/DCT (Discrete Cosine Transform) method which uses a periodic intra-frame encoding process, and has a transfer rate of about 1.5 Mbps. Further, the MPEG 2 is an upper version of the MPEG 1 standard, and directed to a wide transfer rate of several Mbps to several tens of Mbps. The MPEG 1 standard is mainly directed and applied to storage media, such as a CD-ROM. Further, the MPEG 2 standard is directed and applied to broadcasting or an AV device.

Now, when a bit stream outputted from the encoding apparatus as mentioned above is transmitted to a decoding apparatus side, it is necessary to control a data amount on the encoding apparatus side in order to carry out decoding without interruption of continuous images on the decoding apparatus side.

Thus, in order to manage a data amount in the buffer memory on the decoding apparatus side, a virtual buffer of an ideal decoder model called a vbv (Video Buffering Verifier) buffer defined by the MPEG standard is set up in the encoding apparatus, so as to verify the data amount to prevent this vbv buffer from over-flowing or under-flowing. Based on the verification results of this vbv buffer, the encoding apparatus suppresses the data amount of the encode data, or changes a bit rate at the time of transmission, so as to adjust the amount of data (outputted from an encoding apparatus) in the buffer memory on the decoding apparatus side.

Referring now to FIG. 8, a transition state of the amount of accumulated data stored in the vbv buffer when an input image data is encoded in a conventional encoding apparatus will be described. In addition, as for FIG. 8, the description will be carried out while assuming that the bit rate is depicted by R and a period of time between pictures determined by the frame rate is depicted by Tp. Further, the vbv buffer is the virtual buffer memory of the ideal decoder model, as described above, so that the whole capacity (vbv_buffer_size) is set up according to the capacity of the buffer memory on the decoding apparatus side.

Assuming that, for example, encoding of the inputted image data is started from a time t0, subsequently the data is stored in the vbv buffer, for example, at a data transfer rate of a bit rate R. At a time t1 when a time Td lapses from the time t0, if the decoding process is started on the decoding apparatus side, then a data b1 equivalent to a first picture is read from the vbv buffer. At a time t2 when the period of the time Tp elapses from the time t1, a data b2 equivalent to a second picture is read from the vbv buffer. Subsequently, at a time t3, t4, . . . , each period of the time Tp elapses, data b3, b4 equivalent to a third, and a fourth pictures are read from the vbv buffer.

The vbv buffer verifies whether or not the data amount of each picture read at each time exceeds the accumulated data amount at each time by repeating above described operations.

As to how to calculate the accumulated data amount at each time, for example, the accumulated data amount at the time t4, assuming that, for example, an amount of remaining bits of the vbv buffer after the data b3 equivalent to the picture at the time t3 is read is set to B0, an accumulated data amount B1 at next time t4 can be found from the amount of remaining bits B0 at the time t3, the period of the time Tp from the time t3 to the time t4, and the bit rate R, by the following computing equation:
B1=B0+R×Tp

At the time t4, the data b4 equivalent to the fourth picture is read from the vbv buffer. At this time, it is verified whether or not the data b4 equivalent to the fourth picture can be read, while setting an upper limit of the accumulated data amount B1 in the vbv buffer. As a result of this verification, if the data b4 equivalent to the fourth picture is read from the vbv buffer at the time t4 and the vbv buffer under-flows, the vbv buffer is controlled to prevent the under-flow, such as for example, by reducing the data amount for creating an encoded data of the fourth picture in the image compressing and encoding unit, by changing the bit rate for transmitting the data equivalent to the fourth picture, etc.

As a technical literature relevant to this invention, the following patent documents can be listed.

Patent Document 1: Japanese Laid-Open Patent No. H11-262008

### SUMMARY OF THE INVENTION

As mentioned above, in the conventional encoding apparatus, when the accumulated data amount in the vbv buffer is smaller than the data amount equivalent to one picture, a Q (Quantization) scale for creating an encoded data of the picture is increased or a DCT (Discrete Cosine Transform) coefficient is deleted, for example, so that the data amount of the picture may be reduced and the buffer memory on the decoding apparatus side may be controlled so as not to collapse.

However, when such control as mentioned above is carried out, for example, the picture having reduced data amount is a picture which considerably affects an image quality, and for example, the picture having reduced data amount is a picture to be used as a reference image when another picture is decoded, there is a problem with the decoding apparatus in that the image quality may be degraded over several frames.

Especially, when performing the process in a system in which a real time data transmission such as broadcast or communication is required, there is a possibility the encoding apparatus having a structure as mentioned above may cause considerable degradation in the image quality of the decoding apparatus side.

Thus, the present invention is invented in view the above-mentioned points, and an encoding apparatus of the present invention comprises image encoding means constructed to output an encoded data that is the image data obtained by encoding an input image data, and has a different compression degree and a predetermined unit, and for creating and outputting a first encoded data and a skip encoded data having a data amount, at least, less than the above-mentioned first encoded data, when creating the first encoded data having the largest compression degree from the input image data, storage means for temporarily storing the encoded data from this image encoding means, data output means for outputting a bit stream based on the above-mentioned encoded data stored in this storage means, virtual buffer generating means for generating a virtual buffer to virtually request an accumulated data amount in a buffer memory, on a decoding apparatus side, and for temporarily accumulating a bit stream output outputted from this data output means, the data being read from the buffer memory on a per encoded data basis at a predetermined timing, verification means for verifying the accumulated data amount obtained in the accumulated data amount in the virtual buffer according to a creation status of the encoded data, and encode control means for replacing the above-mentioned first encoded data with the above-mentioned skip encoded data so as to perform encode control based on the verification result of this verification means.

Further, an encoding method of this invention is comprises image encoding step constructed to output an encoded data that is the image data obtained by encoding an input image data, and has a different compression degree and a predetermined unit, and for creating and outputting a first encoded data and a skip encoded data having a data amount, at least, less than the above-mentioned first encoded data, when creating the first encoded data having the largest compression degree from the input image data, storage step for temporarily storing the encoded data from this image encoding step, data output step for outputting a bit stream based on the above-mentioned encoded data stored in this storage step, virtual buffer generating step for generating a virtual buffer to virtually request an accumulated data amount in a buffer memory, on a decoding apparatus side, and for temporarily accumulating a bit stream output outputted from this data output step, the data being read from the buffer memory on a per encoded data basis at a predetermined timing, verification step for verifying the accumulated data amount obtained in the accumulated data amount in the virtual buffer according to a creation status of the encoded data, and encode control step for replacing the above-mentioned first encoded data with the above-mentioned skip encoded data so as to perform encode control based on the verification result of this verification step.

According to the above-mentioned structure, when creating the first encoded data from the input image data, the skip encoded data which has the data amount less than this first encoded data is created. Then, based on the verification result of the verification means by using the virtual buffer means, the first encoded data is replaced with the skip encoded data, so that it is possible to adjust the data amount of the bit stream output outputted from the data output means.

According to the present invention as mentioned above, without reducing the data amount of second encoded data which is important when maintaining the quality of image other than the first encoded data, it becomes possible to adjust the data amount of the bit stream output outputted from the data output means. As a result, when a video image is decoded on the decoding apparatus side, the quality of image is not greatly damaged over several frames unlike conventional ones, thus considerably improving the quality of image.

Especially, the encoding apparatus of this invention is very useful when it is applied to an AV system or broadcasting where the video data is needed to be transmitted to the decoding apparatus in real time.

### BRIEF DESCRIPTION OF THE DRAWINGS

FIG. 1 is a block diagram showing a structure of an image encoding apparatus in accordance with an embodiment of the present invention;

FIG. 2 is a block diagram showing a structure of an encoded data output unit in accordance with an embodiment;

FIG. 3 is a chart showing a transition state of a data stored in a vbv buffer in accordance with an embodiment;

FIG. 4 is a chart showing a transition state of the data stored in the vbv buffer in accordance with the embodiment;

FIG. 5 is a chart showing a transition state of the data stored in the vbv buffer in accordance with the embodiment;

FIG. 6 is a block diagram showing a structure of the encoded data output unit in accordance with the embodiment;

FIG. 7 is a flow chart showing a processing performed by an encode control unit of the image encoding apparatus in accordance with the embodiment; and

FIG. 8 is a chart showing a transition state of a data stored in a conventional vbv buffer.

### DESCRIPTION OF THE PREFERRED EMBODIMENT

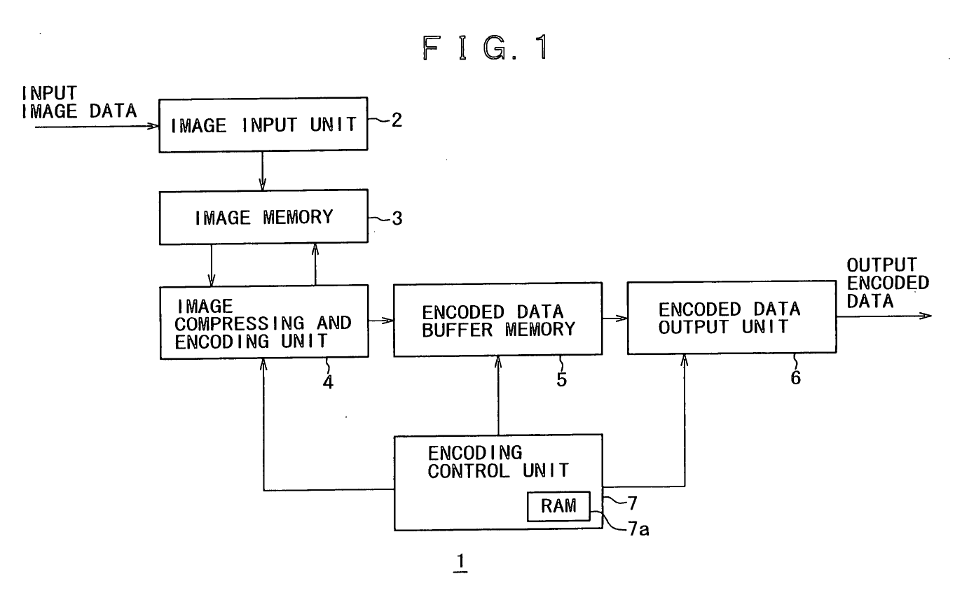

The encoding apparatus in accordance with an embodiment of this invention will be described hereafter. FIG. 1 is a block diagram having shown a structure of an encoding apparatus as one of embodiments. In FIG. 1, an image data inputted through an image input unit 2 is inputted into an image memory 3. The image memory 3 temporarily stores the image data from the image input unit 2, for example.

An image compressing and encoding unit 4 causes the image data stored in the image memory 3 to be subjected to a compressing and encoding process by the MPEG standard and then outputted. In other words, the image compressing and encoding unit 4 divides the image signal (of one frame) into blocks, causes data of each block to be subjected to the DCT (Discrete Cosine Transform), and performs re-quantization in order to further reduce the number of bits (higher components are set to 0). Then, the blocks are sorted and arranged in a zigzag shape starting from a block on the upper left of one frame screen, a run-length encoding process is carried out so as to further reduce the number of bits.

Now, the encoded data created in the image compressing and encoding unit 4 will be described briefly. In the image compressing and encoding unit 4, with regard to each frame of the image signal subjected to the compression process as mentioned above, the temporally preceding and following frames are very similar to each other as image data, whereby the information is further compressed to provide three types of image data (image data for one frame) whose degrees of compression differ from one another. These are referred to as an I picture (Intra Picture), a P picture (Predicted Picture), and a B picture (Bidirectionally predicted Picture).

In this case, the I picture is an image data including only an intra-frame prediction picture. The P picture is an image data generated by way of inter-frame forward prediction. Moreover, the B picture is an image data generated by way of inter-frame bidirectional prediction. Thus, the I picture and the P picture are encoded in the same order as the original picture images. On the other hand, as for the B picture, after processing the I picture and the P picture, the B picture inserted between these pictures is encoded.

Further, a GOP (Group Of Picture) is constituted by a plurality of pictures beginning with an I picture. In this case, in order to perform random access while maintaining independence of each GOP, at least one I picture is needed in one GOP. Furthermore, the last picture of GOP needs to be an I picture or a P picture.

Moreover, when creating an encoded data of B picture (referred to as “B picture data”hereafter) which is the first encoded data, the image compressing and encoding unit 4 of this embodiment creates an image data so-called skip B picture in which any macro block has a coefficient “0”, the same vector, and “0”reference. Thus, the encoded data of the skip B picture (referred to as “skip B picture data” hereafter) which is thus created skip encoded data is outputted together with the B picture data to an encoded data buffer memory 5. In addition, the skip B picture data is uniquely found when the image size is determined.

The encoded data buffer memory 5 takes in and temporarily stores the encoded data encoded in the image compressing and encoding unit 4 so as to output it to an encoded data output unit 6. A real memory size (real capacity) of the encoded data buffer memory 5 has a larger memory size than that of a virtual buffer of a vbv buffer as defined by the MPEG standard.

Thus, in this embodiment, using the fact that the real memory size of the encoded data buffer memory 5 is larger than the memory size of the vbv buffer, the data taken in from the image compressing and encoding unit 4 can be read discretely. In other words, unlike a ring buffer, a FIFO (First-In First-Out) buffer, etc, which are conventionally used, the encoded data buffer memory 5 as in this embodiment can read data which are stored discretely as a continuous data in accordance with an address control.

The encoded data output unit 6 outputs the picture data inputted from the encoded data buffer memory 5 as a stream of data.

An encode control unit 7 controls the image compressing and encoding unit 4, the encoded data buffer memory 5, and the encoded data output unit 6. In other words, in the image compressing and encoding unit 4, the encode control unit 7 performs the control of creating encoded data, such as an I picture and a P picture which are the second encoded data, or a B picture which is the first encoded data, etc., from the image data stored in the image memory 3. Further, when the encoded data of the B picture are created from the image data stored in the image memory 3, a control for creating the encoded data of the skip B picture is also performed.

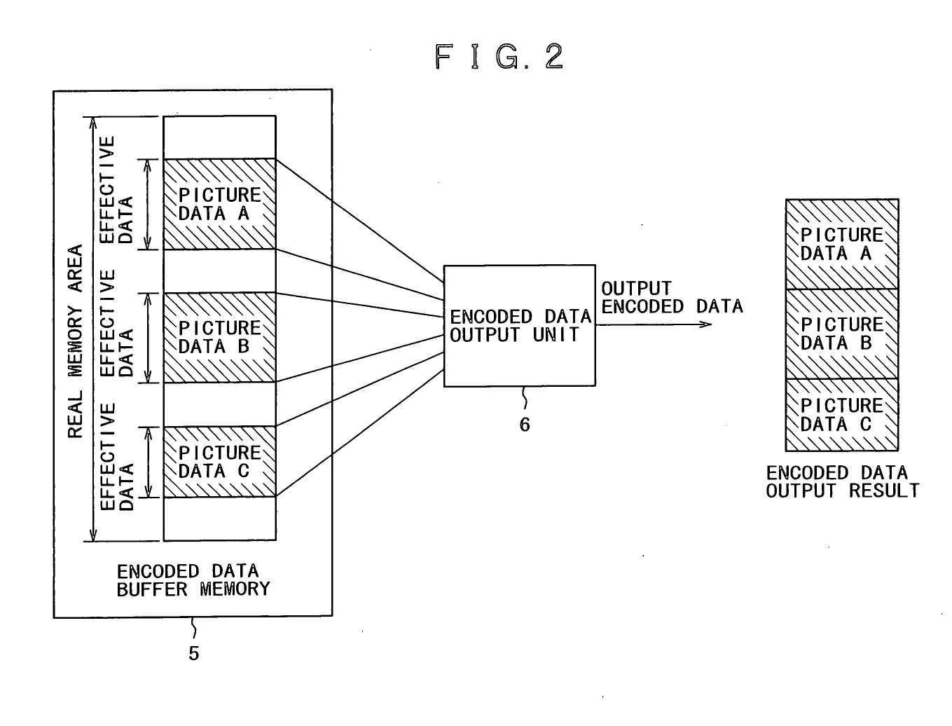

Furthermore, the encode control unit 7 carries out a control of reading and outputting only an arbitrary picture data from the picture data stored and held in the real memory area of the encoded data buffer memory 5. In other words, it is possible to output the picture data discretely stored and held in the encoded data buffer memory 5 as the continuous picture data. For example, as shown in FIG. 2 the encode control unit 7 can output, as the continuous picture data, a plurality of picture data A, B, and C which discretely exist as effective data in the real memory area of the encoded data buffer memory 5. As the result, the encoded data outputted from the encoded data output unit 6 are continuous, for example, in the order of the picture data A, the picture data B, and the picture data C.

Further, in the encoding apparatus 1, when the bit stream output outputted from the encoded data output unit 6 is transmitted to a decoding apparatus (decoder; not shown) side, it is necessary to control the data amount so as to be decoded without interruption on the decoding apparatus side. Thus, the encoding apparatus 1 is provided with the vbv buffer defined by the MPEG standard, as the virtual buffer means for verifying the data amount on the decoding apparatus side. This vbv buffer manages the amount of generating encoded data and controls the data amount on the decoder side so that the buffer on the decoding apparatus side may not collapse.

The vbv buffer, which is such a virtual buffer means, does not exist as a physical memory. For example, the encode control unit 7 employs a RAM (Random Access Memory) 7a etc. provided therein as a work area and performs operation with respect the vbv buffer so as to form the verification means. In addition, the vbv buffer may also use the encoded data buffer memory 5 as the work area.

Further, the encode control unit 7 as the encode control means performs read-out control of the encoded data buffer memory 5, based on the verification result of verified amount of data obtained by the vbv buffer on the decoding apparatus side.

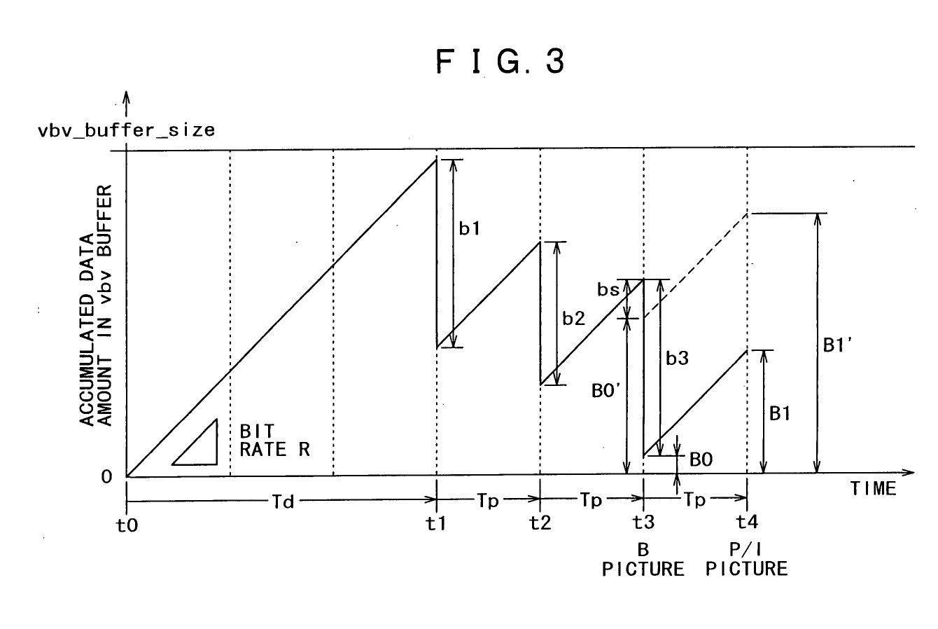

Referring now to FIG. 3 to FIG. 5, a transition state of the accumulated data amount accumulated in the vbv buffer when an input image data is encoded in the encoding apparatus of this embodiment will be described. In addition, in FIG. 3 to FIG. 5, we assume that a bit rate is R and a period of time between pictures determined by a frame rate is Tp.

Also in this embodiment, as mentioned above, the vbv buffer is the virtual buffer of the ideal decoder model, so that the whole capacity size (vbv_buffer_size) is set up according to the capacity size in the buffer memory on the decoding apparatus side.

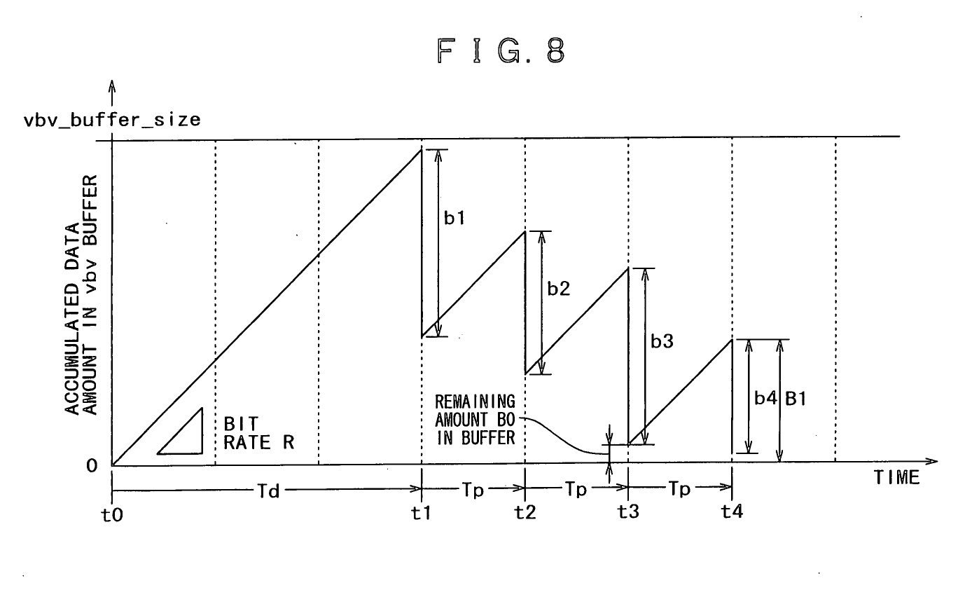

A basic operation of the vbv buffer is the same as that of the conventional vbv buffer as described above by using FIG. 8. In other words, as shown in FIG. 3, for example, if the encoding of the input image data is started from time t0, subsequently the data is stored in the vbv buffer of this embodiment at the bit rate R, for example. At time t1 when time Td elapses from time t0, and at least the data to be stored in the vbv buffer does not overflow, assuming that the decoding process is started on the decoding apparatus side, then, a data b1 equivalent a first picture is read from the vbv buffer. At a time t2 when the period of time Tp elapses from the time t1, a data b2 equivalent to a second picture is read from the vbv buffer. At a time t3 when the period of time Tp elapses from the time t2, a data b3 equivalent to a third picture is read from the vbv buffer. After the time t3, . . . , each time the period of time Tp elapses, a data equivalent to a picture at each time is read from the vbv buffer, and so on.

Thus, the vbv buffer of this embodiment also verifies whether or not the data amount of each picture read at each time exceeds the accumulated data amount at each time by repeating the operation as described above.

As to how to calculate the accumulated data amount at each time, for example, the accumulated data amount at a time t4, assuming that, for example, an amount of remaining bits of the vbv buffer after the data b3 equivalent to picture at the time t3 is read is set to B0, an accumulated data amount B1 at the next time t4 can be found from the amount of remaining bits B0 at the time t3, the period of time Tp from the time t3 to the time t4, and the bit rate R, by the following computing equation:
B=B0+R×Tp

Accordingly, as for the vbv buffer of this embodiment, for example, if the picture data b4 equivalent to fourth picture read from the vbv buffer is the I picture or the P picture at the time t4, the picture data at this time t4 is the data for verification. At the read-out time t3, one data before the time t4, if the picture read from the vbv buffer is the B picture, an amount of remaining bits B0 ′is found when the data b3 of picture read at the time t3 is replaced with the data bs of the skip B picture which is found by way of operation.

The accumulated data amount B1′ at the time t4 when the B picture at time t3 is replaced with the skip B picture can be found by the amount of remaining bits B0′ and the bit rate R and the period of time Tp from the time t3 to the time t4 by the following operation:
B1′=B0′+R×TP

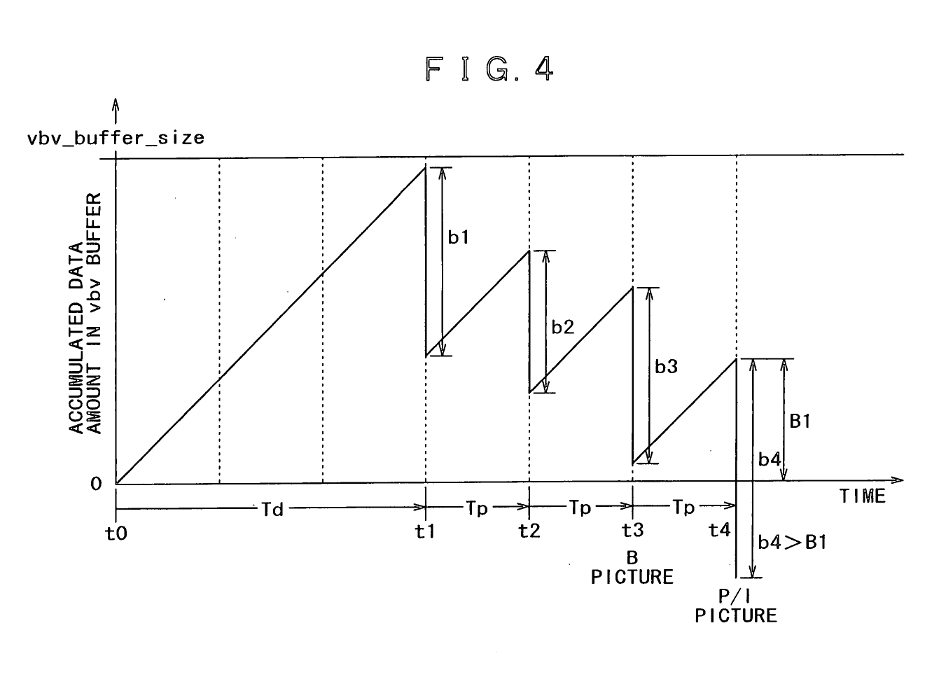

At this stage, assuming that, for example, as shown in FIG. 4, the data b4 equivalent to the picture (I picture or P picture) at the time t4 is greater than the accumulated data amount B1 (b4>B1), in this case the vbv buffer under-flows. In other words, the buffer memory of the decoding apparatus becomes into a situation where data are insufficient.

Thus, the conventional encoding apparatus reduces the data amount when creating the encoded data of the picture at the time t4, changes the bit rate when outputting the bit stream equivalent to the picture, etc., and performs the control of the data.

However, if this picture data is the I picture or the P picture which is to be a reference image when decoding the B picture, then the quality of image may be degraded over several frames as previously mentioned, because not only the image quality of the I picture or the P picture but also the image quality of the B picture used as the reference image are also degraded.

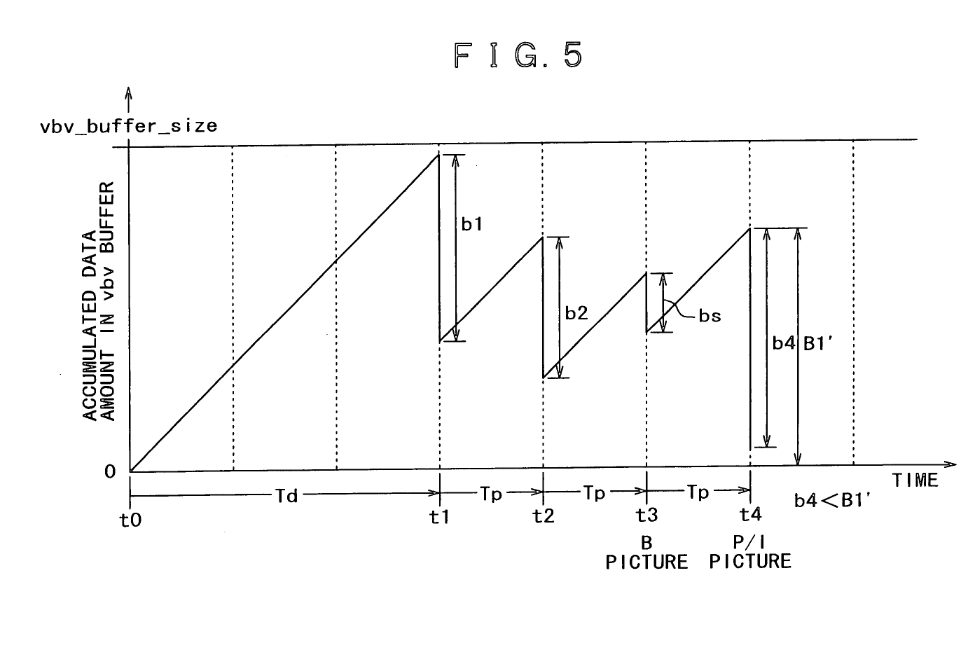

As for the picture at the time t3, when the data b4 equivalent to the I picture or the P picture is greater than the accumulated data amount B1 at the time of B picture (b4>B1) as shown in FIG. 4, the encoding apparatus 1 of this embodiment replaces the B picture with the skip B picture as shown in FIG. 5.

As a result, as shown in FIG. 5 the accumulated data amount B1 at the time t4 is B1′, and the data b4 equivalent to the I picture or the P picture at the time t4 becomes less than the accumulated data amount B1′, so that the vbv buffer may not under-flow. In other words, it becomes possible to verify that the buffer memory of the decoding apparatus in the vbv buffer does not collapse.

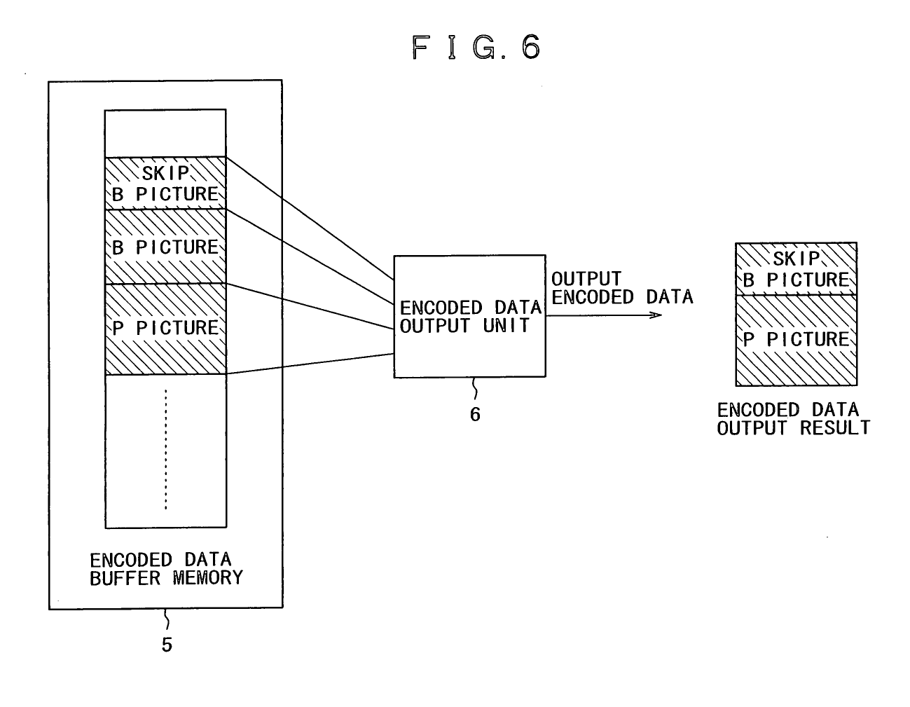

Now using FIG. 6, an operation of outputting the bit stream based on the verification result of the above-mentioned vbv buffers by means of the encoding apparatus 1 of this embodiment will be described. As previously described, the real memory size of the encoded data buffer memory 5 is larger than the memory size of the vbv buffer. Then, the encoding apparatus 1 of this embodiment effectively uses the encoded data buffer memory 5 as mentioned above. In other words, due to the control of the encode control unit 7, the data discretely stored in the encoded data buffer memory 5 is outputted to the encoded data output unit 6 as continuous data, so as to output the bit stream based on the verification result of the vbv buffer.

Thus, when the encode control unit 7 creates the B picture data in the image compressing and encoding unit 4, the encoding apparatus 1 of this embodiment creates the B picture data and the skip B picture data having a data amount less than the B picture data so as to store it in the encoded data buffer memory 5.

As described above, when it is verified that the data amount on the decoding apparatus side exceeds a defined range in the vbv buffer, the B picture data are replaced with the skip B picture data on the encoded data buffer memory 5, and the encoded data output unit 6 outputs only the skip B picture data rewritten on the encoded data buffer memory 5, whereby the encoding apparatus 1 of this embodiment can output the bit stream which does not cause the buffer memory on the decoding apparatus side to collapse.

In addition, when it is verified that the amount of data accumulated does not exceed the defined range in the vbv buffer, a bit stream similar to a conventional one is outputted. In other words, as for the picture data at the time t3, without replacing the B picture data with the skip B picture data on the encoded data buffer memory 5, the bit stream is outputted.

Thus, in the encoding apparatus 1 of this embodiment, based on the verification result of the vbv buffer, the B picture is replaced with the skip B picture, so that the amount of data transmitted to the decoding apparatus side is adjusted without reducing the data amount (of the I picture or the P picture), and this is important when carrying out the decoding in the decoding apparatus and maintaining the quality of image.

Such a construction can improve the image quality, compared with the case where the data amount is reduced by means of a coarse quantization scale process for the I picture or the P picture, for example. This is because the B picture can maintain an average quality of image even if it is processed by means of the coarse quantization scale.

Therefore, the encoding apparatus in accordance with this embodiment can considerably improve the quality of image, and it is very useful when applied to broadcasting, an AV system, etc., where a real time transmission is required.

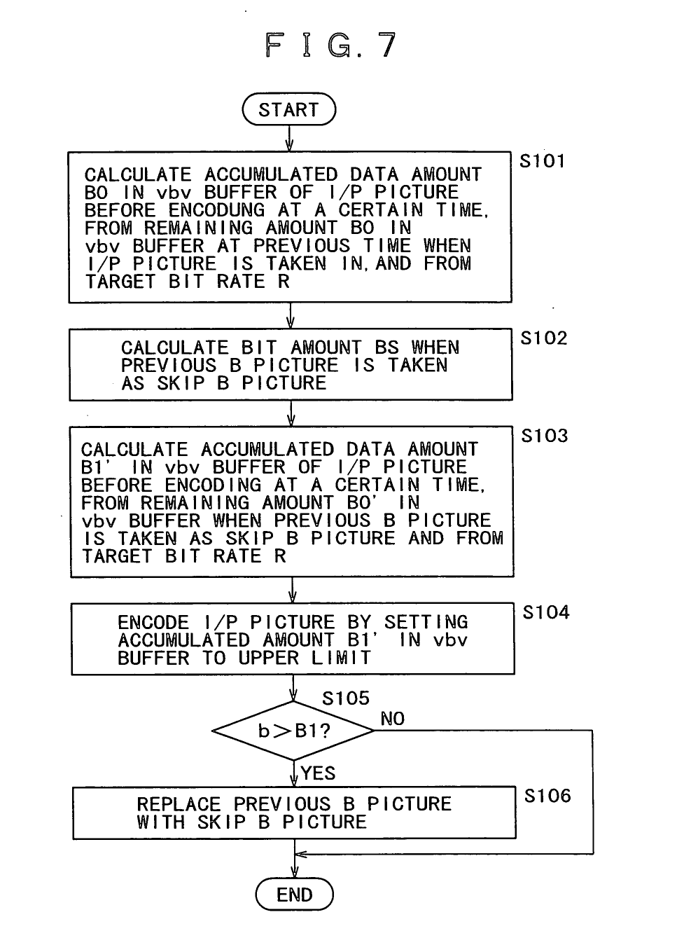

FIG. 7 is a flow chart showing a process performed by the encode control unit 7 in order to realize a verification operation using the vbv buffer as described above. In addition, the following processing operation is performed when the data equivalent to the I picture or the P picture is encoded in the vbv buffer.

In this case, firstly in step S101, the encode control unit 7 calculates the accumulated data amount B1 of the vbv buffer before encoding the I picture or the P picture at a certain time, from the buffer remaining amount B0 in the vbv buffer at previous time when the I picture or the P picture is encoded from the vbv buffer, and from a target bit rate R.

In subsequent step S102, the data bs is calculated when the B picture, one data before, is taken as the skip B picture. Next, in step S103 the accumulated data amount B1′of the vbv buffer before encoding the I picture or the P picture at a certain time is calculated from vbv buffer remaining amount B0′ when the B picture, one data before, is taken as the skip B picture, and from the target bit rate R.

In next step S104, the accumulated data amount B1′ of the vbv buffer is set to the upper limit, and the I picture or the P picture is encoded.

Next, in step S105, it is determined whether or not the picture data of the I picture or the P picture has exceeded the accumulated data amount B1 of the vbv buffer. When it is determined that a data b has exceeded the accumulated data amount B1 of the vbv buffer, the process goes to step S106. Then, in step S106 the B picture, one data before, is replaced with the skip B picture, so as to terminate the process. On the other hand, in step S105 when it is determined that the data b has not exceeded the accumulated data amount B1 of the vbv buffer, the process is terminated without replacing the B picture with the skip B picture. By performing such processes, the operation of the vbv buffer as shown in FIG. 3 to FIG. 5 can be realized by the encode control unit 7.

In addition, the embodiments are described with reference to the encoding method by means of the MPEG standard by way of example. This is only an example, so that it is applicable to another encoding method other than the MPEG standard. Further, the embodiments are described as performing the verification operation by using the vbv buffer in accordance with the present invention when encoding the I picture or the P picture. However, it is also possible to perform it at the time of encoding the B picture. Furthermore, the structure of the encoding apparatus in accordance with the embodiments is only an example. Any encoding apparatus equipped with a virtual buffer may be suitable.

1. An encoding apparatus comprising:
image encoding means constructed to output an encoded data that is the image data obtained by encoding an input image data and has a different compression degree and a predetermined unit, and for creating and outputting a first encoded data and a skip encoded data having a data amount, at least, less than the first encoded data, when creating the first encoded data having the largest compression degree from the input image data;
storage means for temporarily storing the encoded data from said image encoding means;
data output means for outputting a bit stream based on the encoded data stored in said storage means;
virtual buffer generating means for generating a virtual buffer to virtually request an accumulated data amount in a buffer memory, on a decoding apparatus side, and for temporarily accumulating a bit stream output outputted from said data output means, the data being read from the buffer memory on a per encoded data basis at a predetermined timing;
verification means for verifing the accumulated data amount obtained in the accumulated data amount in the virtual buffer according to a creation status of the encoded data; and
encode control means for replacing the first encoded data with the skip encoded data so as to perform an encode control based on the verification result of said verification means.

2. The encoding apparatus as cited in claim 1, wherein;
said verification means, when carrying out verification as a second encoded data other than the first encoded data is set to be a verification target data, obtains a first accumulated data amount when the first encoded data is thought to be encoded data which is immediately before the verification target data, and a second accumulated data amount when the skip encoded data is thought to be encoded data which is immediately before the verification target data; and
said verification means carries out the verification by replacing the first encoded data which is immediately before the verification target data with said skip encoded data when a data amount of the verification target data exceeds said first accumulated data amount.

3. An encoding method comprising:
image encoding step constructed to output an encoded data that is the image data obtained by encoding an input image data and has a different compression degree and a predetermined unit, and for creating and outputting a first encoded data and a skip encoded data having a data amount, at least, less than the first encoded data, when creating the first encoded data having the largest compression degree from the input image data;
storage step for temporarily storing the encoded data from said image encoding step;
data output step for outputting a bit stream based on the encoded data stored in said storage step;
virtual buffer generating step for generating a virtual buffer to virtually request an accumulated data amount in a buffer memory, on a decoding apparatus side, and for temporarily accumulating a bit stream output outputted from said data output step, the data being read from the buffer memory on a per encoded data basis at a predetermined timing;
verification step for verifying the accumulated data amount obtained in the accumulated data amount in the virtual buffer according to a creation status of the encoded data; and
encode control step for replacing the first encoded data with the skip encoded data so as to perform an encode control based on the verification result of said verification step.
